(19) United States
(12) Patent Application Publication
(10) Pub. No.: US 2024/0149571 A1
(43) Pub. Date: May 9, 2024

(54) HIGH BARRIER COLD SEAL LAMINATE AND METHODS OF MAKING THE SAME

(71) Applicant: Sonoco Development, Inc., Hartsville, SC (US)

(72) Inventor: PATRICK PELLIZZARO, Owosso, MI (US)

(21) Appl. No.: 18/503,475

(22) Filed: Nov. 7, 2023

Related U.S. Application Data
(60) Provisional application No. 63/423,238, filed on Nov. 7, 2022.

(51) Int. Cl. B32B 27/08; B32B 7/14; B32B 27/32; B32B 37/12; B32B 37/24; B65D 65/40

(52) U.S. Cl. CPC B32B 27/08; B32B 7/14; B32B 27/32; B32B 37/1292; B32B 37/24; B65D 65/40; B32B 2037/243; B32B 2250/02; B32B 2250/242; B32B 2255/10; B32B 2255/20; B32B 2255/26; B32B 2255/28; B32B 2307/4023; B32B 2307/7244; B32B 2307/748; B65D 2565/386; B65D 2565/387

(57) ABSTRACT

A packaging structure and methods of manufacture are provided herein. The packaging structure comprises a first film layer comprising an outer surface and an inner surface. An in layer comprising titanium dioxide is disposed on the inner surface of the first film layer. An oxygen barrier coating is disposed adjacent the ink layer. A second film layer adhesively joined to the oxygen barrier coating wherein the second film layer metalized polyethylene. A cold seal adhesive is applied to the second film layer opposite the oxygen barrier coating.

### CROSS-REFERENCE TO RELATED APPLICATIONS

This application claims benefit of U.S. Provisional Application No. 63/423,238, entitled “HIGH BARRIER COLD SEAL LAMINATE AND METHODS OF MAKING THE SAME,” filed Nov. 7, 2022, which is incorporated herein in its entirety.

### FIELD OF THE INVENTION

The present invention relates generally to laminate films and methods of making the same, and more particularly to packaging constructed from flexible film-based materials.

### BACKGROUND

Traditional cold seal bar wraps used in the industry may comprise a laminate having films of differing chemistries. The differing film chemistries (i.e., different polymer layers) may prevent the package from being recyclable in the regular stream (e.g., curbside). The differing chemistries in the laminate, however, are typically selected because they provide barrier properties against moisture and oxygen. Through ingenuity and hard work the inventors have designed a mono-material laminate, or a recyclable laminate, with a high barrier, configured for use with a cold seal.

### BRIEF SUMMARY

In an embodiment, the invention is directed to a packaging structure comprising a first film layer comprising an outer surface and an inner surface. The packaging structure may additionally comprise an ink layer, for example, disposed on the inner surface of the first film layer. The ink layer may, in an embodiment, comprise titanium dioxide particles. The packaging structure may additionally comprise an oxygen barrier coating, optionally comprising polyvinyl alcohol, disposed adjacent the ink layer and a second film layer adhesively joined to the oxygen barrier coating. The second film layer may be metalized, machine direction oriented polyethylene in an embodiment. The packaging structure further comprises a cold seal adhesive applied to the second film layer, opposite the oxygen barrier coating.

In some embodiments, the first film layer may comprise polyethylene. In some embodiments, the first film layer may be a cold seal adhesive release film.

In some embodiments, the cold seal adhesive may be pattern applied. In some embodiments, the packaging structure may be recyclable. In some embodiments, the outer surface of the first film layer does not adhere to the cold seal adhesive. In some embodiments, the packaging structure may further comprise an adhesive layer disposed between the oxygen barrier coating and the second film layer.

In another example embodiment, a method of making a packaging structure is provided. The method comprises applying an ink layer to an inner surface of a first film layer. The first film layer comprises an outer surface opposite the inner surface. in an embodiment, the ink layer comprises titanium dioxide. In some embodiments, the titanium dioxide may be about 40% smaller than other ink particles. The method may further comprise, in an embodiment, applying an oxygen barrier coating comprising a soluble PVOH resin to the ink layer. The method may further comprise adhesively joining the oxygen barrier coating to a second film layer, the second film layer optionally being metalized, machine direction oriented polyethylene.

In some embodiments, the ink layer may be applied via reverse printing onto the first film layer. In some embodiments, the ink layer may be flood coated onto the first film layer. In some embodiments, the method may further comprise drying the oxygen barrier coating to evaporate the water from the soluble PVOH resin. In some embodiments, the first film layer may be a polyethylene cold seal release film. In some embodiments, the ink layer may be white. In some embodiments, the cold seal adhesive may be pattern applied. In some embodiments, the packaging structure is recyclable. In some embodiments, the method further comprises adding an adhesive to the second film layer.

In yet another example embodiment, a packaging structure is provided. The packaging structure comprises, in an embodiment, a first film layer comprising an outer surface and an inner surface, and a second film layer that may be metalized and machine direction oriented. The first film layer and second film layer may comprise the same polymer. The packaging structure may further comprise an intermediate layer adhesively joining the inner surface of the first film layer and the second film layer. The intermediate layer may comprise (a) ink comprising titanium dioxide, (b) an oxygen barrier coating, and (c) an adhesive layer. The packaging structure may further comprise a cold seal adhesive disposed on the second film opposite the first film layer.

In some embodiments, the ink layer may be disposed on the first film layer and the oxygen barrier coating may be disposed on the ink layer opposite the first film layer. In some embodiments, the ink layer may be white. In some embodiments, the oxygen barrier coating may comprise a uniform thickness. In some embodiments, the first film layer and the second film layer comprise polyethylene. In some embodiments, a package may be made from the packaging structure.

### BRIEF DESCRIPTION OF THE SEVERAL VIEWS OF THE DRAWING(S)

Having thus described the disclosure in general terms, reference will not be made to the accompanying drawings, which are not necessarily drawn to scale, and wherein

FIG. 1A illustrates a cross sectional view of an example packaging structure, in accordance with some embodiments discussed herein;

FIG. 1B illustrates a cross sectional view of an example packaging structure, in accordance with some embodiments discussed herein;

FIG. 2A illustrates a cross sectional view of a portion of an example packaging structure, in accordance with some embodiments discussed herein;

FIG. 2B illustrates a cross sectional view of a portion of an example packaging structure, in accordance with some embodiments discussed herein; and

FIGS. 3A-B illustrates block diagrams of processes of making the example packaging structure, in accordance with some embodiments discussed herein.

### DETAILED DESCRIPTION

The present invention now will be described more fully herein after with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Flexible packaging, such as bar wrap packages are used for packaging various types of contents including food goods, and other consumables. Bar wrap for example, have been conventionally used to package cookies, crackers, candy bars, nuts and other food items, each of which may be packaged in accordance with the present invention. The contents of the packaging may be degraded through exposure to oxygen and/or moisture, thus, it is necessary to provide certain barrier properties to prevent oxygen and/or moisture from penetrating through the laminate. However, in addition to the barrier, the present invention also seeks to provide a laminate packaging that is recyclable in the regular stream, as each of the film layers comprises the same polymer (e.g., it is a mono material).

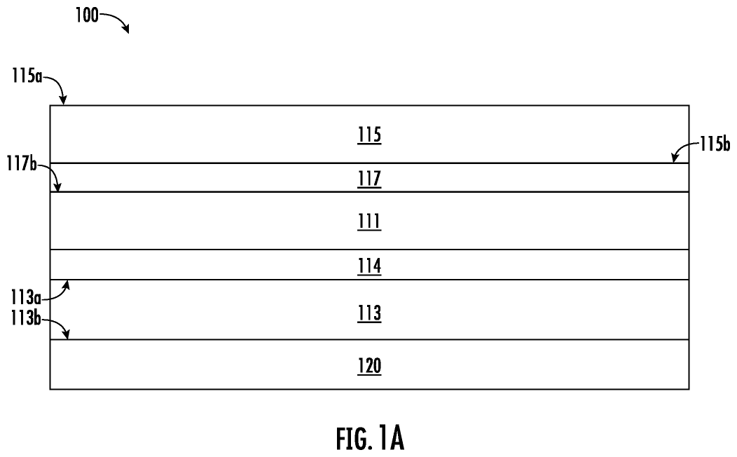

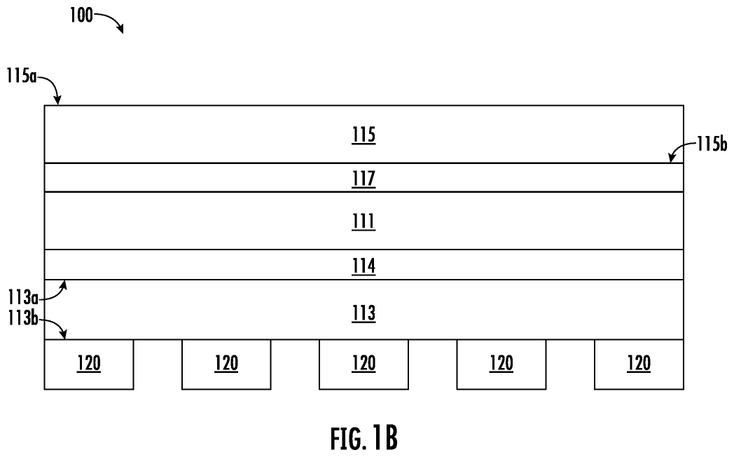

FIG. 1A illustrates an embodiment of a packaging structure in one aspect of the invention, shown in cross section. The packaging structure 100 may comprise a first film layer 115. The first film layer defines an outer surface 115a and an inner surface 115b. The outer surface 115a may be exposed to the environment, while the inner surface 115b may be adhered to other components of the laminate 100.

In some embodiments, the first film layer 115 may be configured as a cold seal release film. A cold seal release film serves the following functions: 1) it provides a film layer which can be printed, or reverse printed (if transparent) so that the decoration is “buried” beneath the transparent layer, to prevent the ink from being worn away; 2) it provides the desired coefficient of friction (COF) properties so that the laminate will run effectively on packaging machines and 3) it provides a surface with low adhesion to a cold seal adhesive so that the laminate roll can be unwound during a packaging operation, with the adhesive remaining on the desired surface of the lamination.

The first film layer 115 may be the outside or exterior film of a multi-web packaging structure of the invention. In some embodiments, the first film layer 115 may be a polyethylene film. In some embodiments, the polyethylene may be medium density polyethylene (MDPE), or high density polyethylene (HDPE), low-density polyethylene (LDPE), linear low density polyethylene (LLDPE), or another type of polyethylene (PE). In some embodiments, the second film layer 113 may be machine-direction oriented (MDO) or biaxially oriented (BO). The first film layer 115 may be configured with release properties, such that a cold seal adhesive may be configured to easily release from the outer surface 115a of the first film layer 115. For example, in an alternative embodiment, the first film layer 115 may have a cold seal release coating applied thereto. In another embodiment the first film layer 115 may comprise integrated cold seal release properties such that the first film layer 115 may not require a cold seal release coating applied thereto.

In some embodiments, the first film layer 115 may be a clear, or transparent, or opaque film, configured for printing or reverse printing. In some embodiments, the first film layer 115 may be surface treated, for example with a corona flame treatment and/or a slip treatment. In some embodiments, the application of a surface treatment on the first film layer 115 may improve retention of the cold seal adhesive release properties.

In some embodiments, an ink layer 117 may be applied to the inner surface 115b of the first film layer 115. The ink layer 117 may be reverse printed, using a rotogravure process or flexogravure. In some embodiments, the ink layer 117 may be flood coated onto the inner surface 115b of the first film layer 115. In some embodiments, the ink layer may be surface printed onto the outer surface of the first film layer.

In some embodiments, the ink layer 117 may be solvent based, solventless, water based, or digital type. In an embodiment, the ink layer 117 may be solvent based and may comprise a mixture of n-propyl alcohol and n-propyl acetate. In an embodiment, the ink layer 117 may be solvent based and may comprise a mixture of ethanol and n-propyl acetate. In an embodiment, the ink layer 117 may be solvent based and may comprise one or more of propylene glycol n-butyl ether, propylene glycol n-propyl ether, and propylene glycol ethyl ether. In an embodiment, the ink layer 117 may be flexographic. In some embodiments, the ink may be white. In some embodiments, the ink may be colored. In some embodiments, the ink may have a solids percentage from about 15% to about 30% (color) or from about 45% to about 55% (white).

In some embodiments, the ink layer 117 may comprise a white pigment. In some embodiments, the white pigment may define a particle size up to 30% smaller than conventional pigment, up to 40% smaller than conventional pigment, and up to 50% smaller than conventional pigment. In some embodiments, the white pigment contains titanium dioxide particles. In some embodiments, the titanium dioxide particles may define a particle diameter size P D size correlating to the reduction in particle size of the white pigment when compared to conventional pigments. In some embodiments, the pigment particles may be sized such that an inner surface 117b of the ink layer 117 defines a smooth and/or hard surface.

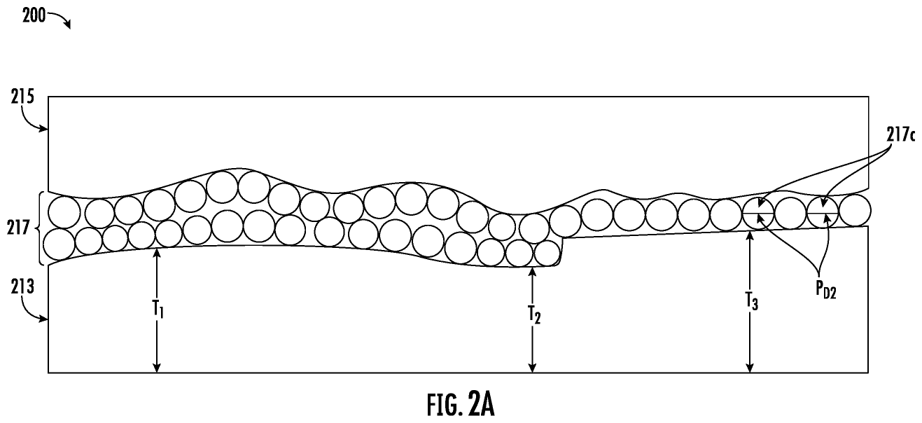

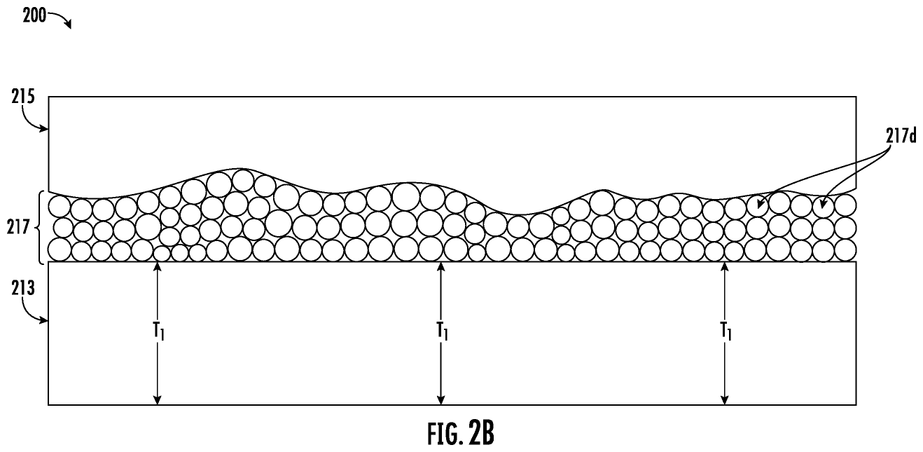

In some embodiments, a barrier layer 111 (e.g., an oxygen barrier coating) may be applied to the inner surface 117b of the ink layer 117. The smooth and/or hard surface of the ink layer 117 may cause the barrier layer 111 to wet out properly and define a uniform thickness across the packaging structure 100. Not wanting to be bound by theory, as illustrated in FIGS. 2A-B, it is understood that the particle size of particles within the ink layer may contribute to the barrier properties of the packaging structure. To explain, as illustrated FIG. 2A an ink layer 217 is adjacent a first film layer 215. The first film layer 215 defines an inner surface 215b which may be uneven. In some embodiments, the inner surface 215b may include imperfections in the film structure creating an uneven thickness of the film across the surface area. In some embodiments, the particle diameter size P_{D2} may be larger than the imperfections on the first film layer 215, and the ink layer 217 may not completely cover the inner surface 215b of the first film layer 215.

Further, when a barrier layer 213 is applied to the ink layer 217, the barrier layer 213 may define varying thicknesses. For example, the barrier layer 213 may define a first thickness T₁ across a portion of the ink layer 217 corresponding to a relatively smooth inner surface 215b, while the barrier layer 213 may define a second thickness T₂ corresponding to a portion of the first film 215 that is thicker in comparison to other portions or comprises protrusion or other imperfections. In some embodiments, the barrier layer 213 may define a third thickness T₃ corresponding to a thinner portion of the first film 215 or a portion with a relatively smooth inner surface 215b. Thus, the barrier layer 213 may not be a uniform thickness across the web 200.

In contrast, the present invention, illustrated in FIG. 2B, utilizes an ink layer 217 with titanium dioxide particles defining a smaller particle diameter size. The smaller particle diameter size allows the particles 217d to form to and coat the imperfections across the first film layer 215. The particles 217d therefore form a more uniform and smooth inner surface 217b for the barrier layer 213 to adhere onto and allow for a more uniform barrier coating thickness T₁. Thus, in contrast to the uneven barrier layer 213 illustrated in FIG. 2A, which may cause weakened (e.g., thinner) spots in the barrier layer 213, the even barrier coating illustrated in FIG. 2B, resulting from the smaller particle diameter size of the titanium dioxide within the ink layer provides a uniform barrier layer, preventing weak (e.g., thin) spots in the barrier layer, therefore providing improved barrier properties (i.e. Lower Transmission Rates).

Returning to FIG. 1A, in some embodiments, the barrier layer 111 may comprise a single component formulation comprising a blend of water and an organic solvent. In some embodiments, the organic solvent may be ethanol or polyvinyl alcohol (PVOH). The barrier layer 111, in an embodiment, may comprise a solids percentage of between about 10% and about 20%. In some embodiments, the barrier layer may be applied to the ink layer 117 to comprise a dry coating weight of at least 0.6 pounds per ream.

In some embodiments, the barrier layer 111 may be reverse printed or flood coated onto the ink layer 117. In some embodiments, the barrier layer 111 may be applied via a flexographic system, gravure roll system, or Mayer rod system. In some embodiments, the barrier layer 111 may be continuous over the entire inner surface of the ink layer 117b. In some embodiments, the barrier layer 111 may have a uniform thickness.

In some embodiments, the barrier layer 111 may be applied to the ink layer 117 as a soluble PVOH resin. The resin may be exposed to heat, thereby causing the water within the resin to evaporate, generating the barrier layer 111. In some embodiments, the barrier layer 111 thickness should account for a reduction in thickness upon drying. The barrier layer 111 may reduce in thickness by up to about 30% when dried. Thus, in an embodiment, the barrier layer may be applied such that the thickness of the dried barrier layer 111 is between 2-3 microns. In yet another embodiment, the barrier layer may be applied such that the thickness of the barrier layer is about 2.5 microns

In some embodiments, an adhesive layer 114 may be applied to adhere the barrier layer 111 to a second film layer 113. The adhesive layer 114 may be applied to the barrier layer 111. In some embodiments, the adhesive layer 114 may be flood coated onto the barrier layer 111, while in other embodiments, the adhesive layer 114 may be pattern applied onto the barrier layer 111.

In some embodiments, the adhesive layer 114, the barrier layer 111 and the ink layer 117 may be called an intermediate layer. In some embodiments, the intermediate layer may adhesively join the first film layer 115 and the second film layer 113.

In some embodiments, the second film layer 113 may comprise the same polymer as the first film layer 115. In some embodiments, the second film layer 113 may be a polyethylene film. In some embodiments, the polyethylene may be medium density polyethylene (MDPE), or high-density polyethylene (HDPE), LDPE, LLDPE, or other type of polyethylene. In some embodiments, the second film layer 113 may be machine-direction oriented (MDO) or biaxially oriented (BO). Oriented polyethylene provides a heat resistant, non-extensible film. These characteristics are important for various aspects of the manufacturing process, such as printing and die cutting or perforating. In some embodiments, oriented polyethylene may improve properties of the packaging structure including adding rigidity, higher durability, adding moisture and aroma barriers.

In an embodiment, the polyethylene film layer(s) of the invention can be modified and, in some instances, improved upon stretching. The stretching may be carried out in the machine direction and known as “mono directional oriented” or machine-direction oriented (MDO) films. MDO films are known to have improved stiffness and impact behaviors. A laminate from MDO-PE may exhibit a high strength in the machine direction.

In some embodiments, the second film layer 113 may be metalized. In some embodiments, the metallization may be on an outer side 113a of the second film layer 113, such that the metallization contacts the adhesive layer 114. Since the metallization will be de minimis, the packaging structure 100 will be readily recyclable. In some embodiments, the metallization may be on one side of the second film layer 113. In some embodiments, the metallized layer may be any metal or oxide including, but not limited to: aluminum, AlOx, and/or SiOx. The metallized layer may be substituted with a coating, film or any other application known in the art.

In some embodiments, a cold seal adhesive layer 120 may be applied to an inner surface 113b of the second film layer 113, opposite the adhesive layer 114. The cold seal adhesive layer 120 may be printed onto or flood coated onto the second film layer 113, illustrated in FIG. 1A, or in some embodiments, illustrated in FIG. 1B the cold seal adhesive may be pattern applied. In some embodiments, the cold seal adhesive 120 may be configured to adhere to only other portions of the cold seal adhesive, with pressure.

The term “cold seal,” as used herein, refers to a seal or adhesive provided at ambient temperature, typically 15-26° C., as opposed to a seal provided with a high-temperature sealant polymer that requires heat and pressure to create the seal. Because of the ability to form seals without heat, cold seal adhesives are ideally suited to the packaging of heat-sensitive products, such as bakery and confectionary products. In addition, employing cold seal adhesives allows faster packaging speeds to be achieved relative to the use of high-temperature sealant polymers.

In some embodiments, the packaging structure 100 may be formed into a package for dry products including candy bars, snack bars, nut snack bars, protein bars, energy bars, nutritional bars, nuts, protein packets, and the like. In an embodiment, the packaging structure 100 may be formed into a package for food products having a high moisture content. In some embodiments, the second film layer 113 may comprise the product facing side of a food package, and the packaging structure 100, specifically the first film layer 115 may comprise the exterior layer. In some embodiments, the barrier layer 111 may further act as a barrier between the ink layer 113 and the product contained within the package. In some embodiments, the packaging structure 100 may be formed into a flow wrap package, a bar wrap, a slug wrap, a pouch, and pillow package, and in some embodiments, may be configured into a stand-up package.

### Method of Manufacture

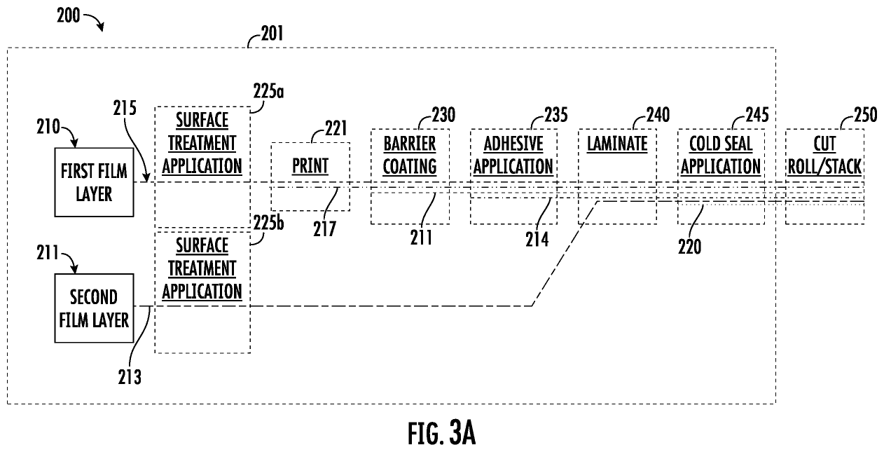

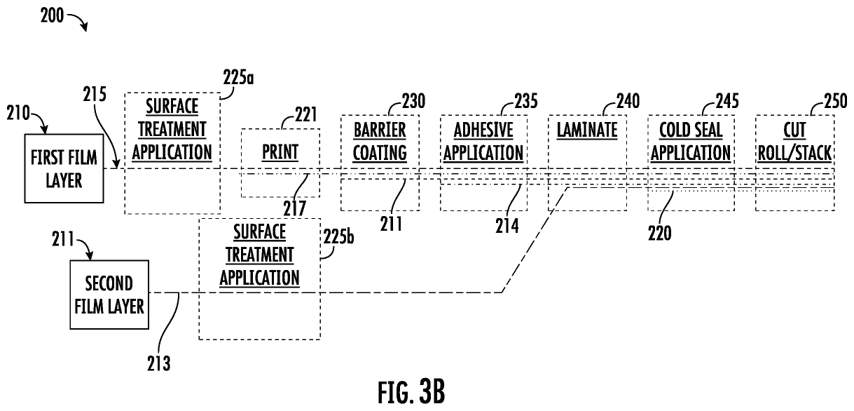

In the method of manufacture 200, referring to FIGS. 3A-B, a first film layer 215 may be advanced from a first film supply roll 210. In some embodiments, the first film layer 215 may advance to a surface treatment station 225a. In some embodiments, the surface treatment may be a corona flame treatment or similar to render the first film layer 215 more receptive to additional layers discussed herein. The first film layer 215 may be advanced to a printing station 221. At the printing station an inner surface of the first film layer 215 may be printed with an ink layer 217. In some embodiments, the ink layer 217 may be applied to the surface treated side of the first film layer 215. In some embodiments, the ink layer 217 may be applied with a flexographic system, gravure roll system, Mayer rod system, sprayed, or digital printed or any other method known in the art. In some embodiments, the ink layer 217 may be flood coated over the entire surface of the inner surface of the first film layer 215.

In some embodiments, the printed first film layer may advance to a barrier coating station 230. At the barrier coating station, a barrier layer 211 may be applied to the ink layer 217. In some embodiments, the barrier layer 211 may be applied with a flexographic system, gravure roll system, Mayer rod system, sprayed, or other coating method. The barrier layer 211 may be dried before lamination to a second film layer 213.

In some embodiments, the barrier coated first film layer may advance to an adhesive application station 235. At the adhesive application, an adhesive layer 214 may be applied to the barrier coating 211. In some embodiments, the adhesive layer 214 may be flood coated, while in other embodiments the adhesive layer 214 may be pattern applied.

In some embodiments, a second film layer 213 may be advanced from a second film layer roll 211. The second film layer may be advanced to a surface treatment station 225b. In some embodiments, the surface treatment stations 225a, 225b may apply the same surface treatment, while in other embodiments the surface treatment stations 225a, 225b may apply different surface treatments. In some embodiments, the surface treatment stations 225a, 225b may be the same station, while in other embodiments, the surface treatment stations 225a, 225b may be independent of one another.

In some embodiments, the surface treatment may be on the outer side of the second film layer 213.

In some embodiments, the second film layer 213 may be laminated to the first film layer 215, ink layer 217, barrier layer 211, and adhesive layer 214 at a lamination station 240. In some embodiments, the first and second structures may be laminated together, such as via a pair of rolls forming a nip therebetween. The first and second structures may be passed through the nip and laminated to each other. In some embodiments, the ink layer 217, the barrier layer 211 and the adhesive layer 214 are the joining layers and the first film layer 215 and the second film layer 213 are the outer layers. In some embodiments, the second film layer 213 may be attached to the first film layer 215, the ink layer 217, the barrier layer 211 and the adhesive layer 214 vie extrusion lamination.

In some embodiments, after lamination the structure may be advanced to a cold seal application station 245. In some embodiments, a cold seal layer 220 may be applied to the second film layer 213 at the cold seal application station 245. In some embodiments, the cold seal layer 220 may be pattern applied, while in other embodiments the cold seal layer 220 may be flood coated onto the second film layer 213.

In some embodiments, the manufacturing process may be completed on a rotogravure, illustrated in FIG. 3A, wherein each of the stations, (e.g., surface treatment station 225a, 225b, printing station 221, barrier coating station 230, adhesive station 235, lamination station 240, and the cold seal application station 245) may be performed in a single pass of a single machine 201. In another embodiment, illustrated in FIG. 3B, the manufacturing may be complete on a flexogravure, wherein the stations are positioned in multiple machines, and the laminate, may take one or more pass through each machine.

In a typical process, the laminate would then be advance to a processing station 250. In some embodiments, the processing station 250 may be a reel-up where it is wound into a roll for subsequent processing in a second, offline scoring phase of the manufacturing process, and a third, off-line application phase of the manufacturing process (e.g., slitting, stacking and packaging). In some embodiments, however, the slitting steps of the invention may be performed in-line with the lamination steps. In the process of the invention, the manufacture of the laminate are conducted in an in-line fashion as part of the same overall process. The process of the invention thus is much more efficient and less costly.

In an embodiment, the packaging structure may be advanced from the processing station 250 and may be formed into packages or may be cut and stacked and/or rolled to be transported to a separate facility for packaging.

### EXAMPLES

### Example 1

In this experiment, the inventors compared oxygen transmission rates of a packaging structure with (a) a packaging structure comprising the particle-containing ink and barrier coating described herein versus (b) a packaging structure with a conventional ink and the barrier coating described herein, and (c) a packaging structure with a conventional ink and conventional barrier coating. In the experiment, the first film layer 115 was a cold seal release polyethylene film, and the second film layer 113 was metalized machine direction oriented polyethylene. In each trial, the ink layer 113 and the barrier layer 111 were applied to the film layers 115, 113 at the same ratio using the same method. The oxygen transmission rate (OTR) for each sample was measured as cc/100 in²/day at approximately 23° C., and 0% relative humidity in 100% O₂. The results of the OTR are shown in Table 1.

TABLE 1
OTR (cc/100 in2/day) at 23° C./0% RH with 100% O2

| | Conventional | Conventional | Non-Conventional |
|---|---|---|---|
| | Ink and | Ink and Non- | Ink and Non- |
| | Conventional | Conventional | Conventional |
| Replicate # | Barrier | Barrier | Barrier |
| 1 | 5.37 | 1.84 | 0.48 |
| 2 | 5.35 | 2.50 | 0.42 |
| Mean | 5.36 | 2.17 | 0.45 |
| Std. Dev. | 0.01 | 0.47 | 0.04 |

As can be seen, the addition of the ink layer 117 described herein and the barrier layer 113 described herein leads to a significantly lower OTR. The OTR results utilizing the non-conventional ink and non-conventional barrier, even as compared to a conventional ink and non-conventional barrier, were particularly compelling. Thus, in an embodiment the packaging structure 100 of the present invention has an OTR of less than 0.48 cc/100 in²/day. The goal for OTR is less than 0.5 cc/100 in²/day.

As illustrated in Table 1, the OTR of the packaging structure 100 of the present invention decreased by a factor of 11.7 times, or in different terms the intermediate layer including the ink layer 117 and the barrier layer 113 generated a 91.6% decrease in OTR when compared to a structure with a conventional ink and barrier layer.

As can be seen, the ink layer 117 and the barrier layer 113 of the invention lead to a significantly lower OTR.

The oxygen transmission rate was tested with an Ox-Tran 702 with 100% O₂ and at 23 C and 0% RH. The oxygen transmission rates were compensated to a barometric pressure of 760 mmHg. For the tests, the metallized surface was positioned towards the carrier gas for testing, in accordance with ASTM 3985.

What is claimed is:

1. A packaging structure comprising:
a first film layer comprising an outer surface and an inner surface;
an ink layer disposed on the inner surface of the first film layer, wherein the ink layer comprises titanium dioxide;
an oxygen barrier coating comprising polyvinyl alcohol, disposed adjacent the ink layer;
a second film layer adhesively joined to the oxygen barrier coating wherein the second film layer is metalized polyethylene; and
a cold seal adhesive applied to the second film layer opposite the oxygen barrier coating.

2. The packaging structure of claim 1, wherein the first film layer comprises polyethylene.

3. The packaging structure of claim 1, wherein the first film layer is a cold seal adhesive release film.

4. The packaging structure of claim 1, wherein the cold seal adhesive is patterned applied.

5. The packaging structure of claim 1, wherein the packaging structure is recyclable.

6. The packaging structure of claim 1, wherein the outer surface of the first film layer does not adhere to the cold seal adhesive.

7. The packaging structure of claim 1, further comprising an adhesive layer disposed between the oxygen barrier coating and the second film layer.

8. A method of making a packaging structure comprising:
applying an ink layer to an inner surface of a first film layer wherein the first film layer comprises an outer surface opposite the inner surface, wherein the ink layer comprises titanium dioxide;
applying an oxygen barrier coating to the ink layer, wherein the oxygen barrier coating comprises a soluble polyvinyl alcohol resin;
adhesively joining the oxygen barrier coating to a second film layer, wherein the second film layer is metalized polyethylene; and
applying a cold seal adhesive to the second film layer opposite the oxygen barrier.

9. The method of claim 8, wherein the ink layer is applied via reverse printing onto the first film layer.

10. The method of claim 8, wherein the ink layer is flood coated onto the first film layer.

11. The method of claim 8, further comprising drying the oxygen barrier coating to evaporate the water from the soluble polyvinyl alcohol resin.

12. The method of claim 8, wherein the first film layer is a polyethylene cold seal release film.

13. The method of claim 8, wherein the ink layer is white.

14. The method of claim 8, wherein the cold seal adhesive is pattern applied.

15. The method of claim 8, wherein the packaging structure is recyclable.

16. The method of claim 8, further comprising applying an adhesive to the second film layer.

17. A packaging structure comprising:
a first film layer comprising an outer surface and an inner surface;
a second film layer, wherein the second film layer is metalized, and wherein the first film layer and the second film layer comprise the same polymer;
an intermediate layer adhesively joining the inner surface of the first film layer and the second film layer, wherein the intermediate layer comprises an ink comprising titanium dioxide, an oxygen barrier coating and an adhesive layer; and
a cold seal adhesive disposed on the second film layer opposite the first film layer.

18. The packaging structure of claim 17, wherein the ink layer is disposed on the first film layer and the oxygen barrier coating is disposed on the ink layer opposite the first film layer.

19. The packaging structure of claim 17, wherein the ink layer is white.

20. The packaging structure of claim 17, wherein the oxygen barrier coating comprises a uniform thickness.

21. The packaging structure of claim 17, wherein the first film layer and the second film layer comprise polyethylene.

22. A package made from the packaging structure of claim 17.
